(19) United States
(12) Patent Application Publication
(10) Pub. No.: US 2012/0161926 A1
(43) Pub. Date: Jun. 28, 2012

(54) DISPLAY APPARATUS WITH TOUCH-SENSITIVE SCREEN LOCK/UNLOCK FUNCTION AND METHOD THEREOF

(75) Inventors: QIANG YOU, Shenzhen City (CN); REN-WEN HUANG, Shenzhen City (CN); JUN-WEI ZHANG, Shenzhen City (CN); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/116,028

(22) Filed: May 26, 2011

(30) Foreign Application Priority Data
Dec. 25, 2010 (CN) 201010605341.3

(51) Int. Cl. G06F 7/04

(52) U.S. Cl. 340/5.54

(57) ABSTRACT

A display apparatus and a method for locking and unlocking a touch-sensitive screen are provided. A user interface is provided on the display apparatus for a user to set at least two types of passwords. At least two types of passwords displayed on the user interface are stored when input of the at least two types of passwords ends. The touch-sensitive screen is locked according to any one of the at least two stored types of passwords. The touch-sensitive screen is unlocked if an input password matches any one of the at least two types of passwords.

### BACKGROUND

1. Technical Field

The present disclosure relates to display apparatuses and, particularly, to a display apparatus capable of locking/unlocking a touch-sensitive screen of the display apparatus and a method thereof.

2. Description of Related Art

Touch-sensitive screens may be unlocked by any of several well-known procedures, such as entering a code or password. In using a password to lock or unlock a screen, a single type of password is often used, however, employing only one type of password protection can be troublesome if a user forgets the password.

### BRIEF DESCRIPTION OF THE DRAWINGS

The components of the drawings are not necessarily drawn to scale, the emphasis instead being placed upon clearly illustrating the principles of a display apparatus with touch-sensitive screen lock/unlock function and a method thereof. Moreover, in the drawings, like reference numerals designate corresponding parts throughout several views.

FIG. 1 is a block diagram of a display apparatus with touch-sensitive screen lock/unlock function in accordance with an exemplary embodiment.

FIG. 2 is a schematic view showing a user interface provided by the display apparatus of FIG. 1.

FIG. 3 is a flowchart of a method for locking/unlocking the touch-sensitive screen of the display apparatus of FIG. 1 in accordance with an exemplary embodiment.

### DETAILED DESCRIPTION

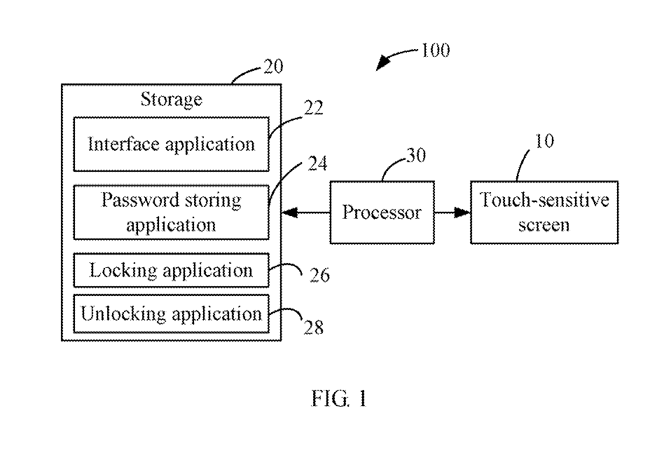

Referring to FIG. 1, a display apparatus 100 includes a touch-sensitive screen 10, a storage 20, and a processor 30. The processor 30 executes/runs various software components in the storage 20 to perform various functions of the display apparatus 100. The storage 20 stores an interface application 22, a password storing application 24, a locking application 26, and an unlocking application 28.

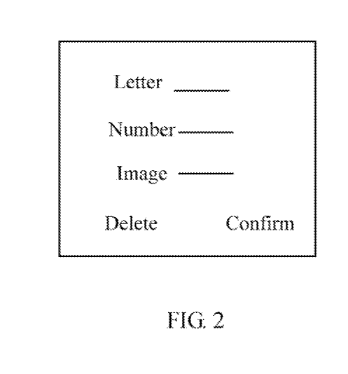

Referring to FIG. 2, the interface application 22 includes various software components and/or set of instructions, which may be implemented by the processor 30 to provide a user interface for a user to set at least two types of passwords. In this embodiment, the user interface includes three password input areas. The first password input area is for inputting the first type of password consisting of letters, the second password input area is for inputting the second type of password consisting of numbers, and the third password input area is for inputting the third type of password consisting of at least one image. The user interface further includes a virtual delete button and a virtual confirm button. The virtual delete button generates delete signals for discarding the character ahead of the cursor's position in response to user touch. The virtual confirm button generates confirm signals for confirming input of the at least two types of passwords in response to user touch. The password storing application 24 includes various software components and/or set of instructions, which may be implemented by the processor 30 to store the at least two types of passwords displayed on the user interface in the storage 20 upon receiving the confirm signals, that is, the password storing application 24 is implemented by the processor 30 to store the at least two types of passwords when input of the at least two types of passwords ends. The locking application 26 includes various software components and/or set of instructions, which may be implemented by the processor 30 to lock the touch-sensitive screen 10 according to any one of the at least two types of passwords stored in the storage 20.

The unlocking application 28 includes various software components and/or set of instructions, which may be implemented by the processor 30 to unlock the touch-sensitive screen 10 if an input password matches any one of the at least two types of passwords stored in the storage 20. The unlocking application 28 is further implemented by the processor 30 to prompt the user to input another one of the at least two types of passwords if one of the at least two types of passwords has been incorrectly entered three times. For example, if the type of password consisting of letters is incorrectly entered three times, the unlocking application 28 is implemented by the processor 30 to prompt the user to enter the type of password consisting of numbers or the type of password consisting of at least one image.

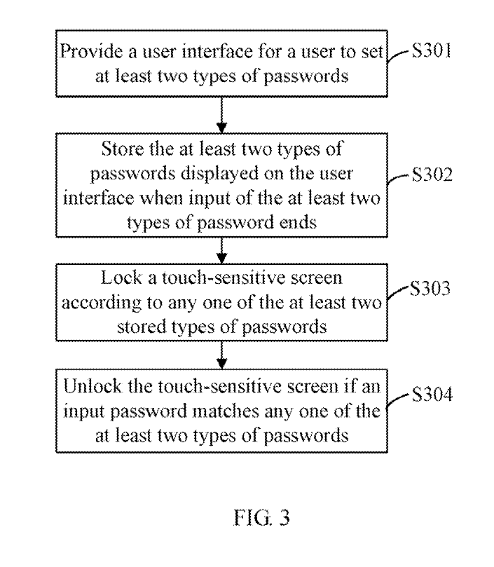

FIG. 3 is a flowchart of a method for locking and unlocking the touch-sensitive screen 10 of the display apparatus 100 in accordance with an exemplary embodiment.

In step S301, the interface application 22 is implemented by the processor 30 to provide the user interface for the user to set at least two types of passwords.

In step S302, the password storing application 24 is implemented by the processor 30 to store the at least two types of passwords displayed on the user interface when input of the at least two types of password ends.

In step S303, the locking application 26 is implemented by the processor 30 to lock the touch-sensitive screen 10 according to any one of the at least two types of passwords stored in the storage 20.

In step S304, the unlocking application 28 is implemented by the processor 30 to unlock the touch-sensitive screen 10 if an input password matches any one of the at least two types of passwords stored in the storage 20.

In this embodiment, the unlocking application 28 is further implemented by the processor 30 to prompt the user to input another one of the at least two types of passwords if one of the at least two types of passwords has been incorrectly entered three times.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A display apparatus comprising:
a touch-sensitive screen;
a storage storing a plurality of modules; and
a processor to execute the plurality of modules:
wherein the plurality of modules comprises instructions executable by the processor to:
provide a user interface for a user to set at least two types of passwords;
store the at least two types of passwords displayed on the user interface in the storage when input of the at least two types of passwords ends;
lock the touch-sensitive screen according to any one of the at least two types of passwords stored in the storage; and
unlock the touch-sensitive screen if an input password matches any one of the at least two types of passwords stored in the storage.

2. The display apparatus as described in claim 1, wherein the plurality of modules further comprises instructions executable by the processor to:
prompt the user to enter another one of the at least two types of passwords if one of the at least two types of passwords has been incorrectly entered three times.

3. The display apparatus as described in claim 1, wherein the at least two types of passwords comprise a first type of password consisting of letters, a second type of password consisting of numbers, and a third type of password consisting of at least one image.

4. A method for locking and unlocking a touch-sensitive screen, comprising:
providing a user interface for a user to set at least two types of passwords;
storing the at least two types of passwords displayed on the user interface when input of the at least two types of passwords ends;
locking the touch-sensitive screen according to any one of the at least two stored types of passwords; and
unlocking the touch-sensitive screen if an input password matches any one of the at least two types of passwords.

5. The method as described in claim 4, further comprising:
prompting the user to enter another one of the at least two types of passwords if one of the at least two types of passwords has been incorrectly entered three times.

6. The method as described in claim 4, wherein the at least two types of passwords comprise a first type of password consisting of letters, a second type of password consisting of numbers, and a third type of password consisting of at least one image.
